(19) United States
(12) Patent Application Publication
(10) Pub. No.: US 2003/0219006 A1
(43) Pub. Date: Nov. 27, 2003

(54) Virtual end-to-end coder/decoder capability in H.323 gateways

(76) Inventor: Benjamin Yuh Loong Har, Singapore (SG)

Correspondence Address: LAWRENCE N. GINSBERG, 21 SAN ANTONIO, NEWPORT BEACH, CA, 92660-9112, US

(21) Appl. No.: 10/152,480

(22) Filed: May 21, 2002

(51) Int. Cl. H04L 12/66

(52) U.S. Cl. 370/352; 379/88.17

(57) ABSTRACT

In Internet Protocol (IP) telephony systems, H.323 gateways delay communications transmissions and compromise quality by requiring multiple codec translations between originating and destination endpoints.

A method and several novel components to reduce communications delays and improve video and audio quality in IP telephony systems are described. The method and components apply a single coder-decoder (codec) for the entire communication path between originating or calling endpoints and destination or called endpoints when calls are connected through H.323 gateways.

The method and components enable H.323 gateways to offer codec capabilities to endpoints even though the H.323 gateways themselves do not have required codec algorithms. This “profession” of codec capabilities that gateways themselves do not possess allows such gateways to dynamically support any codec virtually, as long as the endpoints themselves have the required codec algorithms.

### BACKGROUND OF INVENTION

### DESCRIPTION OF THE RELATED ART

With the growth in demand for H.323 packet-based multimedia communications systems for telecommunications platforms, there has evolved many products and technologies to meet the growing need for IP Telephony. Many such technologies conform to the standards defined by International Telecommunications Union (ITU) document ITU-T Recommendation H.323 Packet-Based Multimedia Communications Systems.

The basic definition of a H.323 gateway as given by ITU is, “An H.323 gateway (GW) is an endpoint on the network which provides for real-time, two-way communications between H.323 terminals on the packet-based network and other ITU terminals on a switched circuit network, or to another H.323 Endpoint.”

Today, coder-decoder (codec) capabilities for communications from one H.323 endpoint (EP) to another endpoint using a H.323 gateway are negotiated separately and independently by the H.323 gateway between these terminal endpoints. The H.323 gateway will match and decide capabilities with its connecting endpoints based on the set of native codecs in a priority list built into the gateway. If a H.323 gateway lacks the codec capabilities to match a connecting H.323 endpoint (EP), then the calling EP will not be able to call its destination through this gateway even though both endpoints may share a common codec capability.

This represents a major weakness in the current art of H.323 products and therefore necessitates one critical requirement: H.323 gateway products must support a well-established codec such as G.723.1, or have a large a multiplicity of codecs.

Although the presence of a wide range of codecs on a H.323 gateway does have its advantages, there are price-and-performance tradeoffs. Many of the better codec algorithms are patented and costs are involved in licensing their technology for use. Each codec also requires guaranteed amounts of short but intensive computer processing cycles to code and decode at high speeds. This means that increased investments in hardware for H.323 gateways are required to support multiple codecs. This adversely affects the prices of H.323 gateways.

Another issue is the delay resulting from codec translations. In performing codec translations, H.323 gateways operate by decoding all incoming codec formats to a common format, commonly either linear PCM or G.711. Then the outgoing process will encode from the common format to the destination codec.

In a call between two endpoints using a H.323 gateway where the two endpoints are using low bandwidth connections (for example dial-up modems connected to internet service providers), up to two codec translations are often needed by the gateway. There is firstly a translation from incoming format to a common format like G.711 or PCM linear using a hardware or software transcoder unit, followed by a translation from G.711 or PCM linear to the codec of the destination.

The findings noted by U.S. Pat. No. 6,256,612 in the prior art clearly substantiates that multiple codec translations have adverse effects on speech quality resulting from delays. With the current state of the Internet where quality of service is not assured, such delays in multimedia delivery of greater than 150 milliseconds is often not tolerable by users.

With reference to the prior art, it is noted that H.323 endpoints are able to establish communications without the use of gateways. Furthermore U.S. Pat. No. 6,373,839 describes a method by which endpoints maintain “common codec attribute lists” so that the highest priority common codec is always determined. Such a method will not have pervasive acceptance unless the use of special variants of H.323 endpoint devices with “common codec attribute lists” become the de-facto standard.

Therefore, due to these and other drawbacks in codec translations in H.323 systems, a significant improvement is needed in H.323 telephony.

### SUMMARY OF THE INVENTION

This invention relates to a method of reducing communications delay, thereby improving video and audio quality in Internet Protocol Telephony (IP Telephony) systems that conform to the H.323, H.225 and H.245 family of International Telecommunications Union (ITU) standards for packet-based multimedia communication systems.

A method to reduce communications delay by reducing the number of codec translations in current methods is required. Such an invention will enable a single codec to be implemented for an entire communications path without need for special H.323 endpoint devices, as described in U.S. Pat. No. 6,373,839. Such an invention will not require out-of-band signaling such as that described in U.S. Pat. No. 6,256,612, and will be able to achieve its objectives by working algorithmically within the in-band signaling protocol requirements stated in ITU H.225 and H.245. The invention described herein provides such a novel method with novel components to achieve these objectives

In one aspect, the present invention is a method of reducing communications delays in H.323 communication systems by enabling a single coder-decoder (codec) for the entire communication path between calling endpoint and called endpoint when the call is connected through a H.323 gateway.

The endpoints making calls using this invention have their call signaling and control protocol synchronized in-band, such that the codec list of the calling endpoint is sent to the called endpoint, and the single codec selected is common to the two endpoints but which may not be available on the gateway. This significantly reduces latency resulting from codec translations. Because it is in-band, this method will work between any standards-compliant H.323 client endpoints.

When the communications path of calling endpoint and called endpoint are interconnected by more than a single gateway, the present invention provides a method for the interconnecting gateways to synchronize the call signaling and control protocol along the entire path such that calling endpoint and called endpoint arrive at using the highest priority codec common between them on the entire communications path.

This is an advantageous step as it means service providers can improve the quality and lower the cost of Internet multimedia communications simply by asking subscribers to make calls through these enhanced gateways of the present invention.

The present invention is easy to implement as service providers need not persuade subscribers to use new H.323 client devices with special non-standard enhancements.

In another aspect, the method described here enables an enhanced H.323 gateway to connect two endpoints together such that the gateway is able to profess support of a codec it does not actually possess. Instead the gateway manages the call signaling and control protocol of the two endpoints such that a codec format common to the two endpoints is accepted. The enhanced gateway establishes a novel component of this invention, a Virtual Codec Unit (VCU), between the logical channels of the two endpoints that pass multimedia data packets with the correct frame rate, frame size and other necessary codec attributes to control the requirements of the codec used by the two terminal endpoints.

In yet another aspect, the enhanced gateways also possess another novel component, a codec attributes update interface, through an out-of-band signaling method, thereby allowing H.323 clients to use proprietary and private codec implementations between themselves without changes to the gateways. This makes it suitable for organizations needing additional security, such as the military.

### BRIEF DESCRIPTION OF THE DRAWINGS

FIG. 1 is a prior art message flow diagram illustrating the H.323 protocol exchanges between two endpoints and a gateway using the conventional H.323 Q.931 and H.245 call control and signaling recommendations;

FIG. 2 is a message flow diagram illustrating the H.323 protocol exchanges to establish a call between endpoints via a gateway with all nodes using the H.323 Fast Connect call signaling and control protocol (Fast Connect) in accordance with the invention;

FIG. 3 is a message flow diagram illustrating the H.323 protocol exchanges between two endpoints and gateway when the present invention is used by the gateway, and the calling endpoint and the gateway agrees on using Fast Connect, while the gateway and called endpoint is not using Fast Connect;

FIG. 4 is a message flow diagram illustrating the H.323 protocol exchanges endpoints and gateway when all nodes are not using Fast Connect;

FIG. 5 is a simplified block diagram illustrating a Virtual End-to-End Codec (VEEC) method of selecting a codec in accordance with the invention;

FIG. 6 is a diagram illustrating how the VEEC method of FIG. 5 is used to select a single coder-decoder for a communications path interconnected by multiple H.323 routing nodes; and

FIG. 7 is a block diagram illustrating an exemplary H.323 gateway apparatus and its functional components in accordance with the present invention.

### DETAILED DESCRIPTION OF THE INVENTION

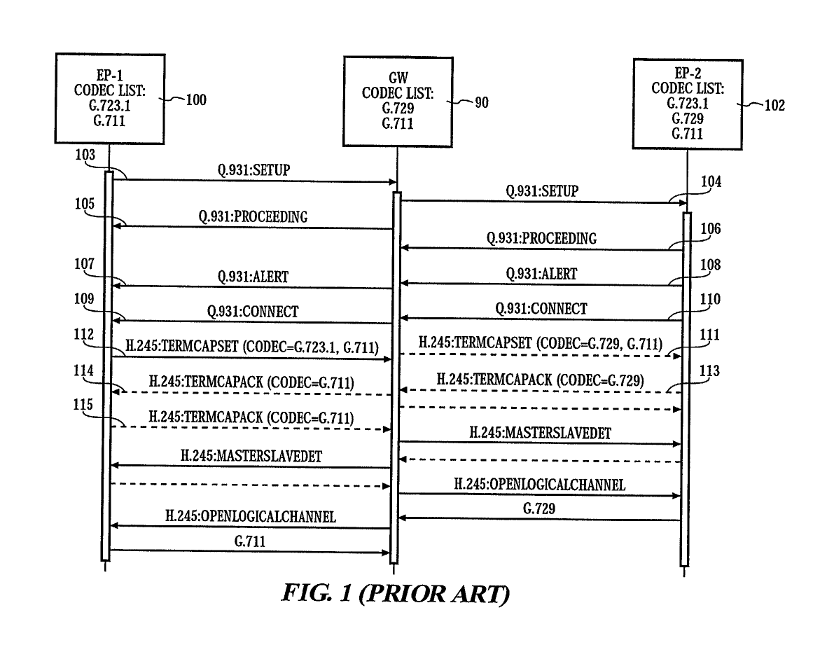

FIG. 1 is a message flow diagram illustrating the prior art of protocol exchanges between two H.323 endpoints and a gateway using the conventional International Telecommunications Union recommendations H.323 (ITU-H.323).

The calling endpoint EP-1 100 supports codec capabilities G.723.1 and G.711. The conventional gateway GW 90 supports codec capabilities G.729 and G.711. The other endpoint EP-2 102 supports codec capabilities G.723.1, G.729 and G.711. These local codec lists are in order of highest to lowest priority as recommended in ITU-H.323. There is no direct path from endpoint EP-1 to the called endpoint EP-2, so the connection is made through gateway GW 90.

Endpoint EP-1 transmits a Q.931 setup request 103 to gateway GW where the destination of EP-2 is specified in the setup request in accordance with ITU-H.323. In the prior art, ITU-H.323 categorises the H.323 call signaling and control protocol into Phase A and Phase B.

Phase A begins at 103 and 104 where Q.931 setup requests are initiated, and the GW monitors and maintains call proceedings and alerts from EP-2 106 to EP-1 105. Phase A ends when the Q.931 Connect request 110 from EP-2 is received by GW and a corresponding Q.931 Connect 109 is established from GW to EP-1.

Phase B starts at endpoint EP-1 requesting H.245 codec capabilities exchange 112 with GW and GW requesting H.245 codec capabilities exchange 111 with endpoint EP-2.

The gateway GW services the incoming call and the outgoing call independently. At 115 GW and EP-1 conclude the H.245 capabilities exchange using G.711 as this is the only common codec between them. Between EP-2 and GW at 113, G.729 is chosen as the highest priority codec common to both.

However EP-2 and GW share two common codecs G.729 and G.711. If EP-2 and GW did not have G.729 and G.711 listed in the identical order as illustrated, they will have ended with using two different codec for transmission and reception. For example if EP-2 had prioritised G.711 before G.729, and both use the priorities of their local list to decide the codec of choice, EP-2 will chose G.711 to transmit to GW and GW will chose G.729 to transmit to EP-2, resulting in two codecs being used.

Another undesirable result is that although EP-1 and EP-2 share the codec G.723.1 they are unable to use it because GW does not have similar capability. Thus gateways of the current technology can disadvantage the use of codecs between endpoints in the ITU-H.323 recommendations.

The present invention is advantageous as it provides a method for codec selection that is an improvement over the prior art as described in the following aspects.

Firstly, it is able to extend the use of a codec capability across gateways even if the gateways do not possess the codec capability (i.e. the codec algorithm). In the prior art, a gateway must have the common codec capability of two connecting endpoints in order for these two endpoints to use the common codec. The present invention defines and uses a Virtual Codec Unit (VCU) to overcome this undesirable effect.

Secondly, the use of two different codecs between endpoints for receive and transmit channels is eliminated. The present invention defines a Virtual End-to-End Codec (VEEC) method that bias the gateway into selecting a common codec for both receive and transmit channels.

The Virtual End-to-End Codec (VEEC) method applied in the embodiment on ITU-T Recommendation H.323 was derived from research into techniques of in-band synchronization of the call signaling and control protocols Q.931 and H.245 between two endpoints and a H.323 gateway.

Three scenarios utilizing VEEC in the present invention is described below to illustrate its use.

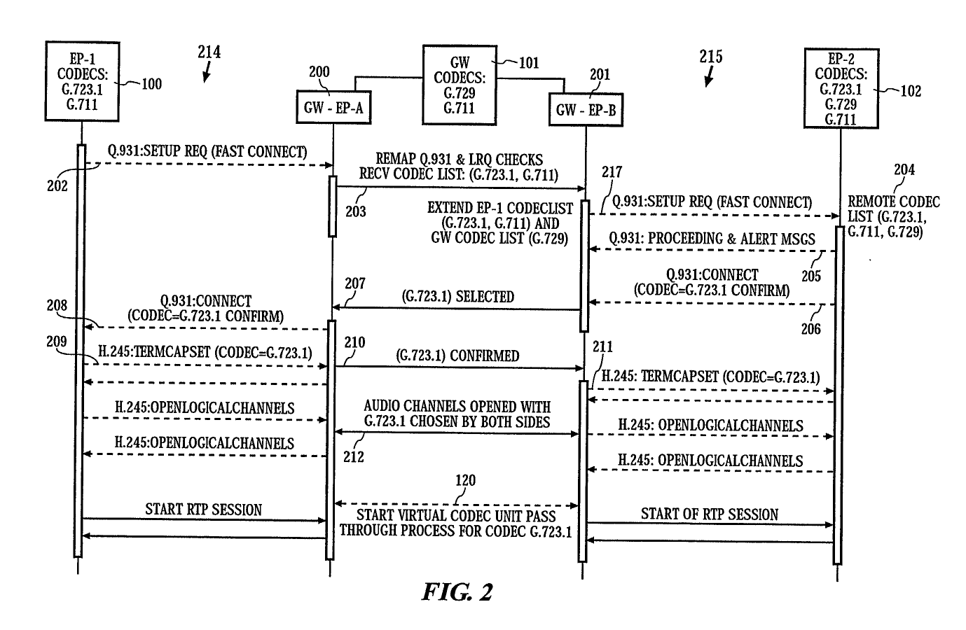

FIG. 2 is a message flow diagram illustrating the VEEC method according to the teachings of the present invention when the H.323 Fast Connect call signaling and control protocol (Fast Connect) is used on both the originating session 214 between endpoint EP-1 100 and gateway GW 101 (a product of this invention), and at the destination session 215 between endpoint EP-2 102 and GW.

As the codec list arrives early with the Q.931 setup request 202 in the Fast Connect, the gateway GW spawns a new process GW-EP-A 200 to service EP-1. In the teachings of this present invention, the gateway GW extracts the codec list of EP-1 from the Q.931 setup message and makes preparations to extend the codec list 203 from EP-1 to EP-2, optionally including GW's local codec list, by creating a remote codec list. The gateway GW spawns a new process GW-EP-B 201, which sends this remote codec list in the Fast Connect Q.931 request 217 to destination endpoint EP-2. As a result of the present invention, endpoint EP-2 receives the remote codec list 204.

The destination endpoint EP-2 sends Q.931 proceeding and alert messages until the Q.931 Connect 206. When the gateway process GW-EP-B receives the Connect Q.931 message 206 from EP-2, it also receives indication that EP-1 will use the extended codec G.723.1.

According to this invention, the gateway GW now completes its Q.931 session 207 with EP-1. Process GW-EP-A sends the G.723.1 codec selected by EP-2 in the Q.931 Connect 208 to EP-1. The resulting H.245 exchange 209 between EP-1 and GW-EP-A will confirm G.723.1 as the single virtual codec to use in the transmitting and receive logical channels 212. A similar H.245 exchange 211 takes place between GW-EP-B and EP-2.

In the teachings of the present invention, the destination endpoint (EP) 102 is delivered an extended list of codec capabilities 204 consisting of the codec list of the originating endpoint (EP) 100 and optionally the codecs of gateways in the call path, the actual combination being beyond the scope of this invention. Therefore the destination endpoint will always be making its codec choice from a more comprehensive list of available codec than without this invention.

Once the destination EP decides on a codec 206, the chosen codec is the only codec passed back to the originating endpoint 208. As the originating endpoint receives one codec capability to chose from in the H.245 exchange 209, a single end-to-end codec is guaranteed to be used along the entire communications path.

By extending the native codec from endpoint to endpoint, the Virtual End-to-End Codec (VEEC) method of the present invention reduces communications delay by eliminating the need for multiple codec translations to be done at the gateway.

selecting a single common codec across the entire communications path, an accurate utilization of effective bandwidth is possible. For if both endpoints are using low bandwidth codecs, then any high bandwidth codec utilized by gateways in between the communications path will effectively have to reduce throughput to the lowest codec denominator at the endpoints.

It will be apparent to someone skilled in the art that the GW, a product of this invention, claims or professes support of the G.723.1 codec even though it does not possess the codec algorithm. To facilitate this virtual codec in the present invention, the basic attributes of the virtual codec, such as its frame size, frame rate, maximum and minimum frame delay must be made available to a Virtual Codec Unit (VCU) 120, a component of the present invention, in order to manage and enhance the effective delivery of the media packets between EP-1 and EP-2.

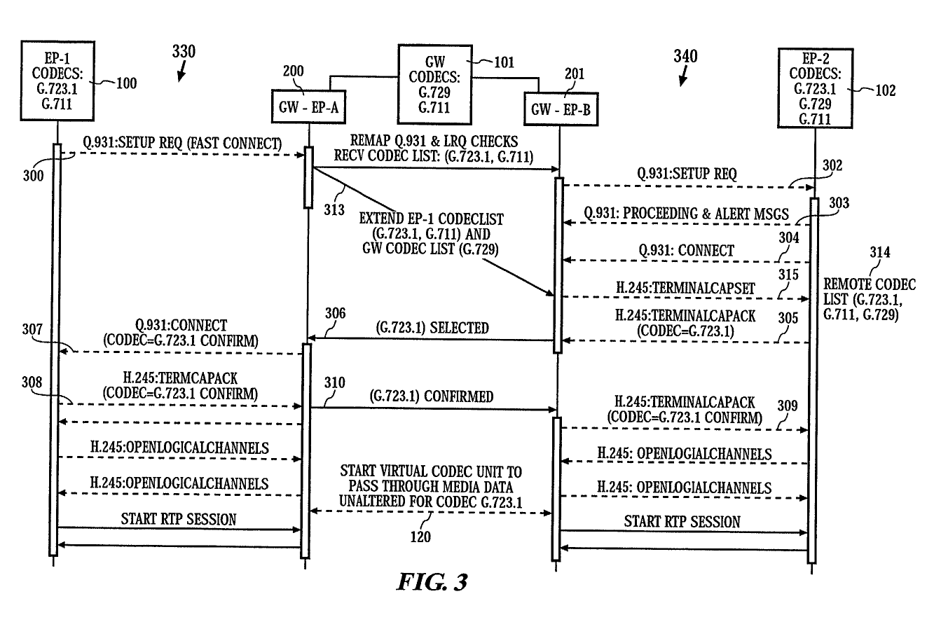

FIG. 3 describes the message flow illustrating a case where the H323 incoming call signalling and control protocol 330 between originating endpoint EP-1 100 and gateway GW 101, a product of this invention, is in the Fast Connect mode and the connecting H.323 call signalling and control protocol 340 between GW 101 and destination endpoint EP-2 102 is in non-Fast Connect mode.

The originating endpoint EP-1 initiates the Q.931 setup request 300 using the H.323 Fast Connect call signaling and control protocol. On receiving the request, the gateway starts endpoint process GW-EP-A 200 that receives the codec lists of EP-1 and call destination information referring to EP-2. The gateway 101 GW starts a new process GW-EP-B 201 that initiates a standard Q.931 call setup request message 302 to destination endpoint EP-2.

In this illustration, EP-2 and gateway process GW-EP-B have decided to use non-Fast Connect call signalling and control protocol. As a result, the Q.931 Setup request 302 does not contain any codec list. This results in a longer call control and signalling sequence where gateway GW has to complete the Q.931 Connection phase (or Phase A) before H.245 capabilities exchange begins.

Process GW-EP-B then waits on proceeding and alert messages 303 from endpoint EP-2 until the Q.931 Connect 304 confirmation arrives from EP-2.

According to the teachings of this invention, the gateway GW prepares to extend a remote codec list 313 to EP-2, consisting of EP-1 codec list and optionally the GW codec list, the actual combination being beyond this invention. The remote codec list is sent in the start of H.245 Capability Set Request 315 to destination endpoint EP-2.

The remote codec list is ordered by the GW, placing the codec list of EP-1 in front of its own codec list. A GW could also be configured to ignore its own codec list and instead, send only the codec of the originating endpoint 100 in the H.245 Capability Set Message. Other alternative strategies to achieve the same results, while not described here, are within the scope and spirit of the present invention.

The teachings of the present invention will result in endpoint EP-2 receiving the capability G.723.1 314 in the remote codec list. The G.723.1 codec is common to EP-1 100 and EP-2 102 but not found in GW 101. The codec G.723.1 is therefore extended through GW 101, a product of this invention, from endpoint EP-1 100 to endpoint EP-2 102. Endpoint EP-2 confirms the use of the extended codec G.723.1 in the H.245 exchange 305 response to GW-EP-B.

According to the present invention, the gateway GW now completes the Q.931 session 306 with EP-1. GW-EP-A passes G.723.1 as the only codec in the Q.931 Connect 307 request to endpoint EP-1. The subsequest H.245 Capability Acknowledgement messages 308 and 309 confirm that a single codec G.723.1 is used by endpoints and gateways on entire communications path.

A person skilled in the art will recognise that with the present invention, it is not possible for endpoints EP-1 or EP-2 to select different codecs for the transmit and receive channels since the GW, a product of this invention, always identifies a single codec in the H.245 negotiation. The GW is also certain that the selected end-to-end codec must be supported by both endpoints since it was instrumental in extending the codec capabilites of both endpoints during the H.323 setup, in accordance with the present invention.

The gateway GW, however, needs to activate the Virtual Codec Unit 312, a component of the present invention, so that media packet data of G.723.1 (or whichever codec that is selected) is relayed in conformance to the attributes of the frame characteristics of the codec.

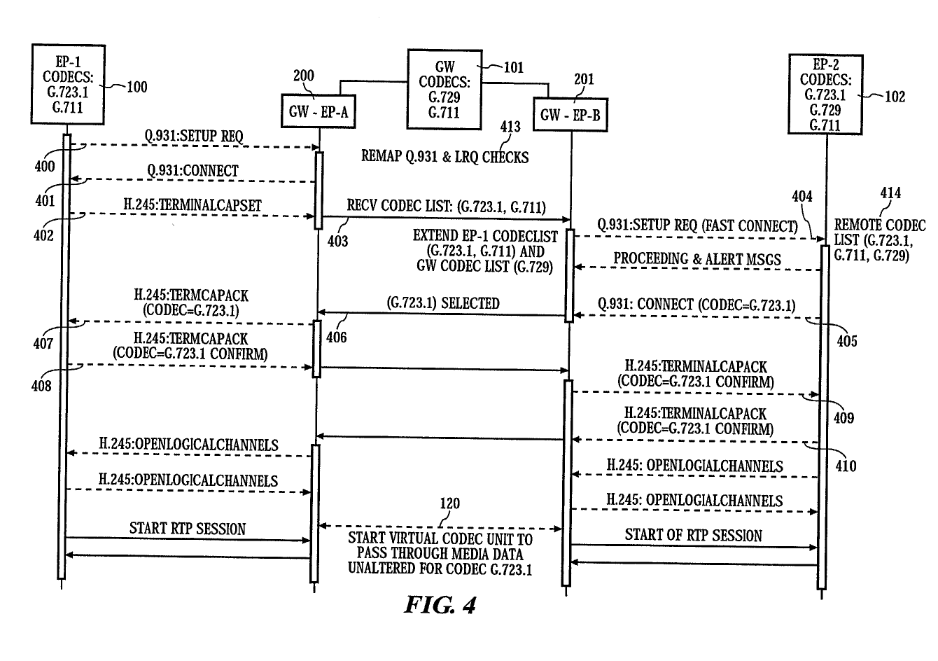

FIG. 4 is a message flow diagram describing how a gateway GW 101, a product of the present invention, would synchronize the call signaling and control protocol exchanges between originating endpoint EP-1 100 and destination endpoint EP-2 102 under the following assumptions:

Endpoint EP-1 is using the basic H.323 call control and signaling protocol without Fast Connect.

Gateway GW is configured to receive both Fast Connect and non-Fast Connect modes of call control and signaling.

Gateway GW is configured to opt for a Fast Connect mode of call control and signaling.

The originating endpoint 100 EP-1 initiates a Q.931 setup request 400 to the gateway GW. This setup request starts an endpoint process GW-EP-A 200. Process GW-EP-A obtains the caller destination of endpoint EP-2 to call 413 from the Q.931 setup message.

According to the teachings of the present invention, gateway GW 101 requires the codec list from the originating endpoint EP-1 before it can initiate a Q.931 setup to the destination endpoint EP-2.

However under International Telecommunications Union H.323 recommendations (ITU-H.323), originating endpoints not using Fast Connect call signaling and control protocol will wait for a Q.931 connect message to solicit for their endpoint codes list.

Therefore to solicit the codec list, process GW-EP-A sends an early Q.931 Connect message 401 back to EP-1. This step is a novel variation of Q.931 call signaling and control protocol claimed under the teachings of the present invention since GW has not really connected with destination endpoint 102 EP-2 at this stage of the process.

a result, endpoint EP-1 starts H.245 terminal capabilities exchange request 402 and sends its priority ordered codec list {G.723.1, G.711} to GW-EP-A. The gateway GW makes preparations to extend the codec list 403 received from EP-1 to EP-2, optionally including the gateway GW local codec list into a remote codec list. The gateway GW starts new process GW-EP-B 201, which initiates a Q.931 Fast Connect Setup request 404 with the remote codec list to destination endpoint EP-2 102.

a result of the teachings of the present invention, the destination endpoint EP-2 has received a list of codecs 414 extending the codec list of the originating endpoint EP-1 to EP-2 via the gateway GW 101, a product of the present invention.

In this scenario, endpoint EP-2 is able to select codec G.723.1 within its repertoire of capabilities. EP-2 responds with a Q.931 connect message 405 back to GW-EP-B, indicating G.723.1 as the chosen codec. The gateway GW starts to complete its H.245 capabilities exchange 406 with originating endpoint EP-1. Process GW-EP-A then sends the H.245 terminal capability acknowledgement 407 with G.723.1 as the choice to EP-1. The following H.245 acknowledgement messages 408 to 410 confirm the use of codec G.723.1 as the end-to-end codec taught by the present invention.

By managing the call connection between endpoint 100 EP-1 and endpoint 102 EP-2 as described above, the gateway GW 101, a product of this invention, succeeds in enabling a single coder-decoder to be used, even whilst the gateway itself does not need to possess the selected G.723.1 codec capability. The gateway GW starts and maintains a Virtual Codec Unit (VCU) 120 to manage data packets in G.723.1 (or whichever selected codec) content and this novel capability enhances the transmission of data, and hence, the quality of audio between the opened logical channels.

A person skilled in the art will appreciate that in the present invention, this Virtual End-to-End Codec selection is biased towards the destination endpoint. Through synchronization of the Q.931 and H.245 call signaling and control protocol as taught by the present invention, the destination endpoint 414 receives a biased codec list consisting of the possible capabilities of the endpoints and gateways on the communications path. Therefore, the destination endpoint will always be making its codec choice from a more comprehensive list of available codecs than without this invention. This has a desirable effect as it ensures that the destination endpoint can always select the best codec.

It will also be appreciated by a person skilled in the art that in the present invention, the gateways can biased the codec selection list given to the destination endpoint in more ways than has been described.

For example, the G.711 codec requires relatively high bandwidth at 64 Kbps for audio. A gateway in the present invention could thus improve the quality of transmission by using a gatekeeper and the International Telecommunications Union (ITU) H.225 RAS signaling functions to ascertain if a destination endpoint is connected to the Internet at bandwidths lower than 64 Kbps. At this speed, G.711 may not produce audio of a desired quality. The gateway 403 in this invention may then alter its strategy and drop G.711 or have G.729 ordered ahead of G.711 in the remote codec list sent to destination endpoint. Similar methods and strategies may be used without departing from the spirit or scope of the present invention.

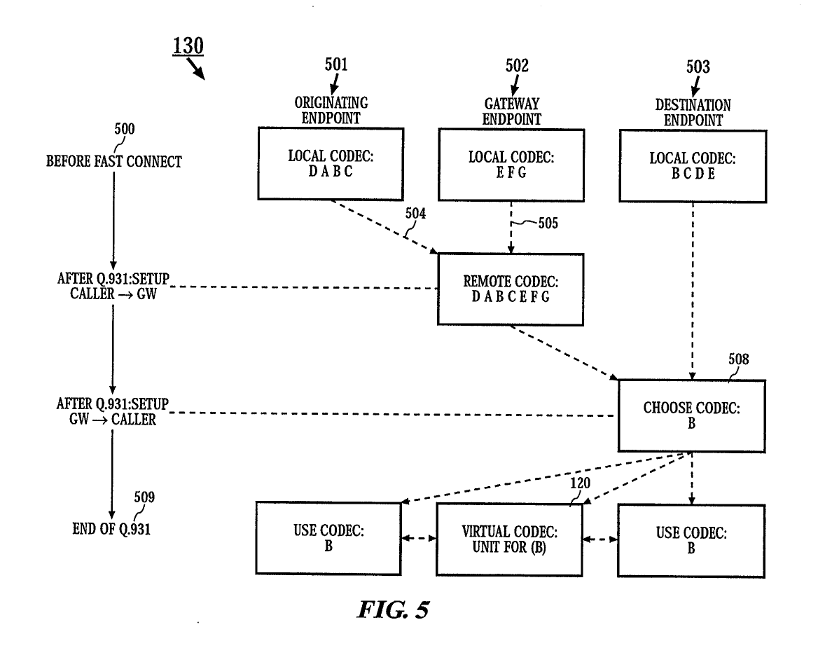

FIG. 5 is a block diagram 130 illustrating the Virtual End-to-End Codec method of the present invention. At the stage before a call is initiated 500, the originating endpoint 501 includes a prioritized list of codecs D, A, B, C. The destination endpoint 503 lists codecs B, C, D, E in order of priority. A gateway device of this invention GW 502 is used to interconnect the two endpoints, listing codecs E, F, G as its preferred list. After the Q.931 Setup in fast connect mode 504, the gateway now derives a merged list of possible codecs (D, A, B, C, E, F, G) forming the remote codec list 505.

If the destination endpoint conforms to conventional ITU H.323 systems, it will select the first codec on its local priority list that also matches the remote codec list. As shown in this particular illustration, codec B is selected in 508.

Since the built-in codec list of the gateway GW is also included in the remote codec list, there is probability that a codec not supported by the originating endpoint but supported by the gateway GW is chosen. As this is undesirable, the GW codec list will then be ignored in step 505 and only the originating endpoint's codecs are passed in the remote list. The result is that at end of the call control protocol 509, the gateway will have to use a Virtual Codec Unit 510, a component of the present invention, to relay the media packets between the endpoints.

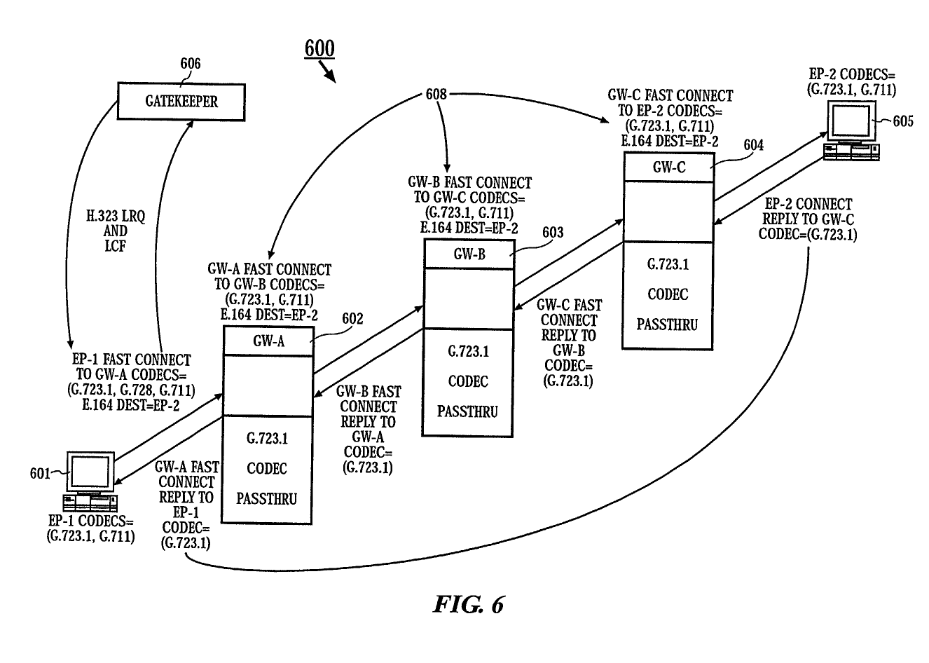

FIG. 6 illustrates the teachings of the present invention in a typical telephony over Internet application. The routing of data packets through multiple gateway routers called “hopping points” facilitates all Internet traffic. Assuming for example, that the endpoint computers EP-1 and EP-2 share an Internet traffic path interconnected by three gateway routers 600 as depicted in FIG. 6. These gateway routers GW-A 602, GW-B 603 and GW-C 604 all support H.323 protocol but in addition have the ability to implement an end-to-end coder-decoder in accordance with the methods taught in the invention. EP-1 601 and EP-2 602 are two H.323 endpoints that wish to initiate communications via H.323 protocol. EP-1 uses a gatekeeper 606 to determine whether it should connect to GW-A for establishing the Q.931 Setup 607.

Using the current invention, GW-A, GW-B, GW-C can act as transparent extenders 608 for the Q.931 requests and H.245 capability exchanges for EP-1 and EP-2 to setup a H.323 communications path between the endpoints, using a single end-to-end coder-decoder that is known and acceptable between the two endpoints.

The present invention is advantageous as the Virtual Codec Unit (VCU) and Virtual End-to-End Codec (VEEC) method can be embedded in hardware as special add-on adaptors or attachments to existing gateway routers, transforming them to gateway routers that support the teachings of the present invention and H.323 protocol.

The invention can also be manifested as software and added to software-based routers and computers to enhance such equipment, enabling them to support the VEEC method in synchronizing the H.323 call signaling and control protocol. The requirement of coder-decoder functionality in software or hardware is made redundant with this invention for H.323 gateways. This then provides an attractive proposition for service providers to offer Internet telephony services to customers with lower capital investment requirements.

While the present invention as described has used voice transmission for illustration, it will be apparent to one skilled on the art that other multimedia data may be similarly transmitted between H.323 endpoints using the present invention.

Again, while the present invention is illustrated as transmission of multimedia between two endpoints, communications between more than two endpoints along plural logical channels is also possible and is within the scope and spirit of the present invention.

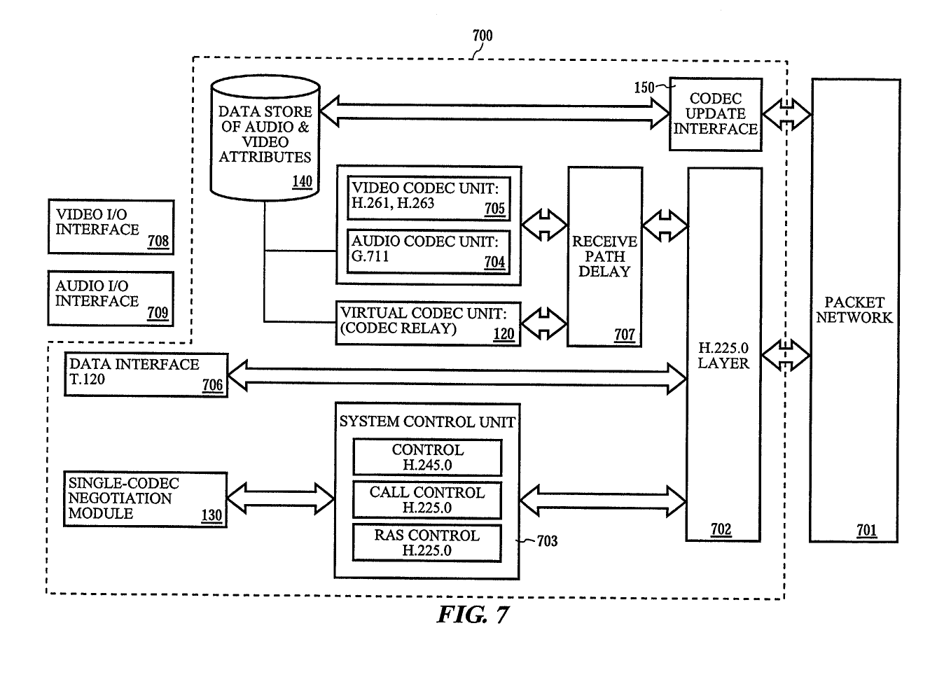

FIG. 7 is a general block diagram of a H.323 gateway 700 according to an embodiment of the present invention. The gateway is connected to a packet network 701, which physically allows the gateway to be accessible by other H.323 devices and for the gateway to access other H.323 devices.

FIG. 7 also shows the components included within the scope of the ITU-H.323: H.225.0 layer 702, System Control Unit 703, Audio Codec 704, Video Codec 705, Data Interface 706 and Receive Path Delay 707. The video input/output (I/O) Interface 708 and audio I/O Interface 709 may be part of a gateway if the gateway is to support direct connect with external equipment such as phone sets, video monitors, cameras, public switched telephone network (PSTN) switches, etc.

In order to fulfill the Virtual End-to-End Codec (VEEC) method of the present invention, the gateway 700 will have to include the Single Codec Negotiation Module 130 (SCNM), another component of the present invention, and the Virtual Codec Unit 120 (VCU). The SCNM is a logic module used to control the H.323 call signaling protocol between connecting H.323 endpoints so that the methods of extending codec capabilities from endpoint to endpoint, codec list extension and single end-to-end codec determination, as taught in the present invention, may be implemented. The VCU completes the VEEC method of professing support for extended codec even though it does not possess the codec algorithm.

facilitate use of this extended codec in the present invention, the basic attributes of the codec, such as its frame size, frame rate, maximum and minimum frame delay are made available to the VCU from some permanent memory Data Store Device 140 as shown in FIG. 7. The actual ITU-H.323 Audio and Video Codec in the gateway would also require these codec attributes for their algorithms, so such an attribute data store can be a shared resource.

In addition, the gateway of the present invention could have a Codec Update Interface (CUI) 150 unit, another component of the present invention, as shown. The CUI defines the concept for dynamic updates of special codec for this invention as follows.

If two endpoints wish to communicate with each other through a gateway of this invention, and the endpoints want to use a special codec whose attributes are not defined in the gateway, one of the endpoints would first use the Codec Update Interface (CUI) to update the gateway with the attributes of the special codec. Then the two endpoints can begin their H.323 call control and signaling protocol through the gateway. The gateway Virtual End-to-End Codec (VEEC) method will implement the special codec between the endpoints, as taught by this invention.

Thus, the CUI facilitates the dynamic addition, deletion, modification and updating of extra codec attributes to improve and extend the capabilities of the VEEC method on the gateway. The CUI would be an out-of-band signaling protocol that will not interfere with the H.323 protocol supported on the same gateway.

What is claimed is:

1. A method of improving transmission quality in Internet Protocol Telephony (IP Telephony) systems, said method comprising the steps of:
calling, by an originating endpoint, a destination endpoint using an enhanced gateway serving originating endpoint,
selecting, by an enhanced gateway, a single selected codec to be used for the entire communications path;
opening of receive and transmit logical channels using said selected codec with both said endpoints, thereby ensuring that only said selected codec is used; and
performing transport or relay of data packets according to attributes of said selected codec for the entire communication path.

2. A method in accordance with claim 1, further comprising the steps of:
utilizing a multi processing step in said enhanced gateway to control call signaling and control protocol for each of said endpoints;
enabling either of said endpoints to communicate a codec list, call signaling status and related information of said originating endpoint to said destination endpoint;
enabling processes from both said endpoints to:
implement inter-process synchronization when handling call signal messages,
negotiate said selected codec to be used for subsequent transmission between said originating endpoint and said destination endpoint, whereby said enhanced gateway is capable of professing support of codec capabilities that said enhanced gateway does not actually possess during call signaling procedure.

3. A method in accordance with claim 1, wherein control of call signaling and control protocol by said enhanced gateway for said selected codec includes the steps of:
sending, by said enhanced gateway, to said destination endpoint, a list of available codecs from said originating endpoint, and
receiving a reply, by said enhanced gateway, from said destination endpoint, specifying selected codec from said list of available codecs.
determining the highest priority codec on codec list supported by both said destination endpoint and said originating endpoint;
selecting said highest priority codec as the selected codec to be used;
determining attributes of said selected codec;
confirming said selected codec with both said endpoints; thereby
ensuring that said selected codec is the only codec used in the entire communications path.

4. A method in accordance with claim 3, wherein selection of selected codec as the only codec for transmission includes the steps of:
receiving said selected codec by said enhanced gateway from said destination endpoint,
synchronization, by said enhanced gateway, a call signal that will dictate that said selected codec is to be used in completing call, and
replying, by said enhanced gateway, said call signal synchronization to said originating endpoint that said selected codec is the only possible codec for transmission.

5. A method in accordance with claim 4, further comprising the step of:
modifying, by said enhanced gateway, the ordering of said codec list to be sent to said destination endpoint whereby said enhanced gateway can influence said selection of a codec by said destination endpoint.

6. An Internet Protocol Telephony system comprising of:
at least two endpoints;
at least one channel; and
at least one enhanced gateway interconnecting said at least two endpoints,
wherein
said system utilizes said at least one enhanced gateway to control call signaling and control protocols such only a single selected codec is selected and utilized in the transmission of data packets between said endpoints.

7. An Internet Protocol Telephony system in accordance to claim 6 wherein said at least one enhanced gateway comprises:
at least one virtual codec unit,
at least one single codec negotiation module, and
at least one codec update interface unit.

8. An Internet Protocol Telephony system in accordance to claim 7 wherein said at least one virtual codec unit of said at least one enhanced gateway receives and transmits data packets corresponding to attributes of said selected codec.

9. An Internet Protocol Telephony system in accordance to claim 6, wherein one or more of said enhanced gateway interconnects two or more endpoints; further wherein said enhanced gateway will negotiates with each other said selected codec for transmission such that said selected codec is common to said endpoints; said enhanced gateways utilizing said virtual codec units to relay said data packets should any said enhanced gateways not possess said selected codec.

10. An enhanced gateway comprising at least one virtual codec unit, at least one single codec negotiation module and at least one codec update interface unit wherein said single codec negotiation module negotiates codec capabilities between said enhanced gateways and said endpoints.

11. An enhanced gateway comprising at least one virtual codec unit, at least one single codec negotiation module and at least one codec update interface unit wherein said codec update interface unit allows the dynamic modification and updating of codec attributes such that any codec can be virtually supported.

12. An Internet Protocol Telephony system in accordance to claim 6, wherein said system conforms to ITU H.323 system standards.

13. An Internet Protocol Telephony system in accordance to claim 6, wherein said call signaling and control protocols may utilize fast connect mode or non-fast connect mode.

14. An Internet Protocol Telephony system in accordance with claim 6, wherein said enhanced gateway initiates preemptive means of solicitation for said codec list if call signaling mode of one said endpoint does not include an unsolicited sending of list of available codecs to said enhanced gateway.

15. A system in accordance to claim 6, wherein said enhanced gateway controls transmission of a call despite said enhanced gateway itself not supporting said selected codec.
